(19) United States
(12) Patent Application Publication
(10) Pub. No.: US 2002/0003113 A1
(43) Pub. Date: Jan. 10, 2002

(54) Methods of recycling polymers containing inorganic additives

(76) Inventor: Pieter Krijgsman, Wapenveld (NL)

Correspondence Address: George Wolken Jr., SKJERVEN MORRILL MacPHERSON LLP, Suite 700, 25 Metro Drive, San Jose, CA, 95110-1349, US

(21) Appl. No.: 09/755,909

(22) Filed: Jan. 3, 2001

Related U.S. Application Data
(60) Provisional application No. 60/174,468, filed on Jan. 3, 2000.

(51) Int. Cl. C02F 1/68

(52) U.S. Cl. 210/749

(57) ABSTRACT

The present invention relates to the separation and recycling of polymer materials containing inorganic additives by means of processing with a solvent under near-critical, critical or supercritical solvent conditions, achieving thereby a segregation of such inorganic additives from the polymeric material. In particular, the yellow colorant cadmium sulfide (CdS) is separated from polyethylene using a water solvent in the critical domain.

### RELATED APPLICATIONS

The present application claims priority from provisional patent application serial No. 60/174,468 pursuant to 35 U.S.C. §119, §120 and other provisions.

### BACKGROUND

1. Technical Field

The present invention relates to methods of treating polymers, plastics and similar polymeric materials for purposes of recycling. More particularly, the present invention relates to methods for concentrating and separating inorganic additives contained in the polymeric material thereby facilitating disposal and/or recycling of the polymer and inorganic additive in an environmentally acceptable manner.

2. Description of Related Art

Almost all commercially important polymeric materials contain additives, consuming annually more than 5 billion kg. of additives just in the United States (Polymer Chemistry, 3d. Ed. by Malcom P. Stevens, p. 121). Such additives are typically used to alter the properties of the polymeric material, to affect the processability of the material, to reduce material costs by including less expensive fillers or extenders, or to achieve a combination of these purposes. Additives may be completely miscible with the polymer, completely immiscible or partially miscible. Additives may be organic compounds, inorganic compounds or mixtures and combinations thereof. For example, colorants may be added to a polymer in order to achieve a desired color and such colorants may be in the form of dyes (typically an organic material), an inorganic pigment or a combination. However, such colorants containing metals (such as yellow CdS) introduce undesirable heavy metals into the formulation. The presence of heavy metals complicates the recycling or disposal of such polymers in an environmentally acceptable manner. Methods to separate inorganic additives from the polymer materials, especially those additives containing heavy metals, is an important objective of the present invention. Such separation and concentration of the inorganic additives facilitates recycling or disposal of the polymer (including the additive) by localizing the inorganic additive (typically more hazardous to the environment) for more specialized, disposal or recycling.

### SUMMARY

The present invention relates to the separation and recycling of polymer materials containing one or more inorganic additives by means of processing with a solvent under near-critical, critical or supercritical solvent conditions, achieving thereby a segregation of such inorganic additives from the polymeric material. In particular, the yellow colorant cadmium sulfide (CdS) is separated from polyethylene using a water solvent in the critical domain by processing in a water solvent for about 5 hours at a temperature of about 374 degrees Celsius under a pressure of about 22.1 MPa.

### DESCRIPTION OF DRAWINGS

FIG. 1: Typical phase diagram for a single pure component, depicting typical solid (S), liquid (L), gaseous (G) and supercritical (SF) regions as well as boundaries separating such regions.

### DETAILED DESCRIPTION

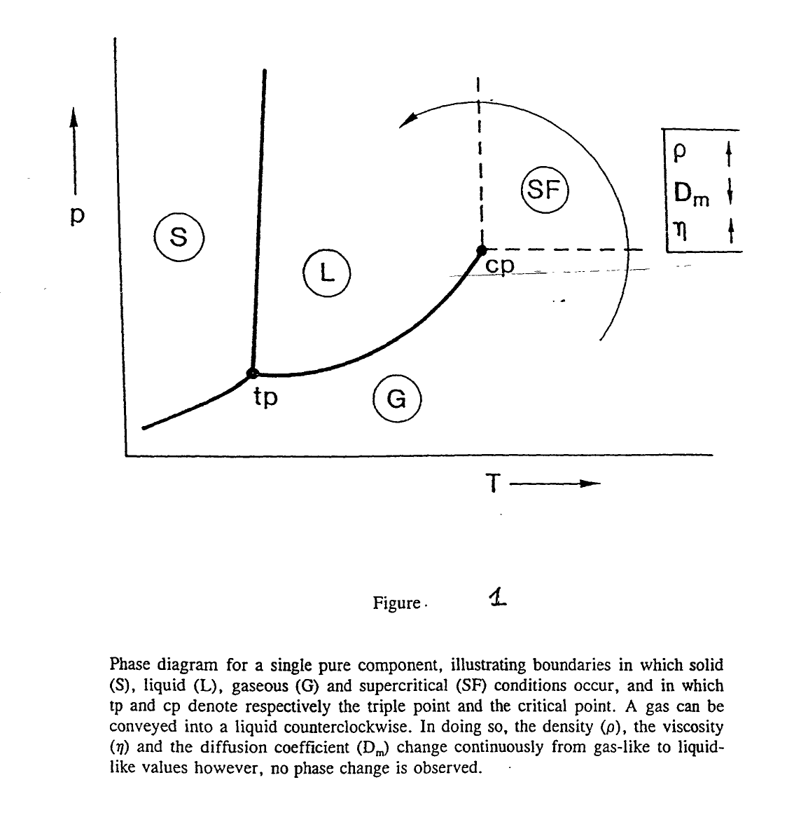

The present invention relates to the separation and recycling of polymer materials containing one or more inorganic additives by means of processing with a solvent under near-critical, critical or supercritical solvent conditions. FIG. 1 depicts a typical thermodynamic phase diagram for a single pure component, and illustrates boundaries in which solid (S), liquid (L), gaseous (G), and supercritical (SF) conditions occur. The label “cp” denotes the critical point in the phase diagram, which is defined by a critical temperature and a critical pressure. For example, for water the critical point occurs at a critical temperature of 647° K (374° C.) and a critical pressure of 22.1 MPa (218 atm). The critical temperatures and pressures for several other solvents are listed in Table 1. Near-critical, critical, and supercritical solvent conditions refer to the regions of the solvent phase diagram in the vicinity of the solvent critical point, at the critical point, and at both higher temperature and higher pressure than the critical point. As the temperature and pressure of a fluid approach their critical values, the densities of the liquid and gas phases of the fluid converge to a single value. At the critical point, and in the supercritical region, the gas and liquid phases of the fluid are indistinguishable (not separated by a meniscus) and the fluid exists in a single phase.

For economy of language we refer to the “critical domain” as conditions of temperature and pressure not too distant from the critical point for the solvent being used. That is, in the critical domain either or both temperature and pressure may be subcritical, critical or supercritical, corresponding to a two-dimensional region in the neighborhood of point cp in FIG. 1. “Critical domain conditions” or “critical domain solvent conditions” refer to processes performed in the critical domain of the particular solvent being used, most commonly water.

Critical domain conditions are advantageous for the processing of materials for several reasons. Among these is the property that the solubility of many materials in solvents under critical domain conditions is enhanced in comparison with typical solubilities. In water, for example, both polar and nonpolar chemical compounds are typically soluble under critical domain conditions while non-polar solubilities in water are typically rather small away from such conditions of temperature and pressure. Some otherwise insoluble oxides dissolve in water under critical domain conditions. It is thought by some that geological mineral formation may occur under conditions approximating the critical domain.

The discussion of critical domains in connection with the present invention is not limited to the example of a single component as depicted for purposes of illustration in FIG. 1. Multicomponent solvents exhibit more complex phase diagrams than that depicted in FIG. 1, having the possibility of various azeotropes, complexes or chemical reaction products in addition to the separate pure substances in mutually soluble, partially soluble and insoluble proportions. The methods of the present invention are not limited to single component solvents. Multicomponent solvents may have conditions of (typically elevated) temperatures and pressures leading to increased solubility of the materials. Such conditions of temperature and pressure may occur in regions in which the densities of multicomponent liquid and gas phases become the same, the analogue of the critical point in a single component solvent. To be definite in our discussion, we will describe the critical domain solvent conditions and present examples primarily in connection with single component solvent, typically water. However, generalization to other solvents and mixtures of solvents are straight forward extensions of the techniques described herein.

The processes described herein are not inherently limited to the separation of a single inorganic additive from a single-component polymeric material. That is, the present invention also can be used with a polymeric material comprising a blend of distinct polymers, including therein one or more inorganic additives, within the scope of the present invention.

As a particular example and not by way of limitation, we describe the separation of yellow colorant cadmium sulfide (CdS) from polyethylene using a water solvent in the critical domain. It is expected that the procedures described herein may be generalized to other inorganic additives in other polymers.

A sample of granulated polyethylene containing cadmium sulfide colorant (yellow) was placed in an autoclave with water solvent. Since granulated polyethylene floats, the sample was contained in a suitable holder to keep the sample submerged in the water solvent. The autoclave was sealed and heated to a temperature of 374° C. A saturated pressure of 22.1 MPa was achieved. After about 5 hours, the temperature was permitted to cool to ambient. Residual pressure in the autoclave was released and the autoclave opened.

The above procedure resulted in a white layer of polyethylene floating on the surface of the water solvent with a small yellow clump remaining in the sample holder (presumably CdS). No odor was detectable in the water solvent. No corrosion or pitting of the autoclave was observed. Thus, the above process achieves a separation of the inorganic additive (in this case, CdS) from the polymer (polyethylene in this particular instance). The resulting volume of CdS is considerably smaller than the original blend of polymer and CdS additive, facilitating subsequent disposal in an environmentally satisfactory manner. Alternatively, the CdS in the yellow concentrate may be of sufficient purity to justify further recycling and reclamation processes. The white polyethylene layer may be handled by conventional procedures for recycling/disposing of polyethylene, well known in the art.

Having described the invention in detail, those skilled in the art will appreciate that, given the present disclosure, modifications may be made to the invention without departing from the spirit of the inventive concept described herein. Therefore, it is not intended that the scope of the invention be limited to the specific and preferred embodiments illustrated and described.

TABLE 1

| | Critical | |
|---|---|---|
| Solvents | Temperature (° K.) | Critical Pressure (MPa) |
| Carbon Dioxide | 304.26 | 7.28 |
| Ethane | 305.46 | 4.82 |
| Ethylene | 282.46 | 4.97 |
| Propane | 369.86 | 4.19 |
| Propylene | 365.06 | 4.56 |
| Cyclohexane | 553.46 | 4.02 |
| Isopropanol | 508.36 | 4.70 |
| Benzene | 562.16 | 4.83 |
| Toluene | 591.76 | 4.06 |
| p-Xylene | 616.26 | 3.47 |
| Chlorotrifluoromethane | 302.06 | 3.87 |
| Trichlorofluoromethane | 471.26 | 4.35 |
| Ammonia | 405.66 | 11.13 |
| Water | 647.36 | 22.12 |

I claim:

1. A method of separating at least one inorganic additive from a polymeric material containing said additives comprising:
a) placing said polymeric material with said at least one inorganic additive therein and a solvent into an autoclave; and,
b) processing said polymeric material with said additive therein and said solvent under critical domain conditions for sufficient time to achieve separation of said inorganic additive from said polymeric material; and,
c) removing said solvent, said polymeric material and said inorganic additive from said autoclave; and,
d) separating said polymeric material from said inorganic additive.

2. A method as in claim 1 wherein said solvent is water.

3. A method as in claim 1 wherein said inorganic additive is cadmium sulfide.

4. A method as in claim 1 wherein said polymeric material is polyethylene.

5. A method as in claim 2 wherein said critical domain conditions comprise heating a sealed autoclave to a temperature of about 374 degree Celsius.

6. A method as in claim 2 wherein said critical domain conditions comprise heating in a sealed autoclave to achieve a pressure of about 22.1 MegaPascal.

7. A method as in claim 2 wherein said sufficient time to achieve separation is about five hours.
